(19) United States
(12) Patent Application Publication
(10) Pub. No.: US 2010/0104092 A1
(43) Pub. Date: Apr. 29, 2010

(54) PROGRAMMABLE CURRENT-BASED HOOK DETECTION

(75) Inventor: Paolo CUSINATO, Villeneuve-Loubet (FR)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/393,163

(22) Filed: Feb. 26, 2009

(30) Foreign Application Priority Data
Oct. 27, 2008 (EP) 08291008.4

(51) Int. Cl. H04M 1/03

(52) U.S. Cl. 379/428.02

(57) ABSTRACT

In at least some embodiments, a communication device includes a processor and a communication interface coupled to the processor. The communication interface has a programmable current-based hook detection circuit for detecting when a telephonic communication starts and ends.

### CROSS-REFERENCE TO RELATED APPLICATIONS

The present application claims priority to EP patent application Serial No. 08291008.4, filed Oct. 27, 2008, entitled “Programmable Current-Based Hook Detection” and hereby incorporated herein by reference.

### BACKGROUND

One of the features of some telecommunication headsets is a start/end switch (a button) to enable the user to receive and to end calls with the simple push of a button. Electronically, the start/end switch can be in parallel or in series with a headset microphone.

FIG. 1 shows an existing hook detection circuit. In FIG. 1, the current flowing in the microphone is detected through a small sense resistor (R_{SENSE}) which acts as a current-to-voltage (I-to-V) converter. A voltage comparator establishes if the start/end switch is opened or closed (whether toggling occurs). This circuit suffers from some inaccuracy due to the spread of R_{SENSE}.

### SUMMARY

In at least some embodiments, a communication device includes a processor and a communication interface coupled to the processor. The communication interface has a programmable current-based hook detection circuit for detecting when a telephonic communication starts and ends.

In at least some embodiments, a hook detection circuit is provided for detecting when a telephonic communication starts and ends. The hook detection circuit includes a current comparator programmable for both series start/end triggers and parallel start/end triggers.

In at least some embodiments, a hook detection method includes selectively setting a current threshold of a current comparator to a first value for series start/end switching. The hook detection method also includes selectively setting the current threshold of the current comparator to a second value different from the first value for parallel start/end switching.

### BRIEF DESCRIPTION OF THE DRAWINGS

For a detailed description of various embodiments of the invention, reference will now be made to the accompanying drawings in which:

FIG. 1 illustrates an existing hook detection circuit;

FIG. 2 illustrates a communication network in accordance with embodiments;

FIG. 3 illustrates a computing system in accordance with embodiments;

FIG. 4 illustrates the headset of FIG. 3 in accordance with embodiments;

FIG. 5 illustrates a hook detection circuit in accordance with embodiments;

FIG. 6 illustrates a current sense arrangement in accordance with embodiments;

FIG. 7A illustrates a series start/end switch arrangement in accordance with embodiments;

FIG. 7B illustrates a parallel start/end switch arrangement in accordance with embodiments; and

FIG. 8 illustrates a hook detection method in accordance with embodiments.

### NOTATION AND NOMENCLATURE

Certain terms are used throughout the following description and claims to refer to particular system components. As one skilled in the art will appreciate, computer companies may refer to a component by different names. This document doe not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Embodiments are directed to systems and methods for hook detection. In accordance with at least some embodiments, a hook detection circuit is programmable for use with series start/end switching or parallel start/end switching (i.e., the start/end switch is either in series or in parallel with a microphone). The hook detection circuit implements current sensing rather than voltage sensing to establish if the start/end switch is toggled.

FIG. 2 illustrates a wireless network 200 in accordance with embodiments. To provide wireless data and/or communication services (e.g., telephone services, Internet services, data services, messaging services, instant messaging services, electronic mail (email) services, chat services, video services, audio services, gaming services, etc.), the network 200 comprises an access point (AP) 220 and any of a variety of fixed-location and/or mobile wireless devices or stations (STAs) (referred to individually herein as device, station, STA or device/station), four of which are respectively designated in FIG. 2 with reference numerals 210A, 210B, 210C and 210D. It should be appreciated that the network 200 is meant to be illustrative and not exhaustive. For example, it should be appreciated that more, different or fewer communication systems, devices and/or paths may be used to implement embodiments. Exemplary devices 210 include any variety of personal computer (PC) 210A with wireless communication capabilities, a personal digital assistant (PDA) or MP3 player 210B, a wireless telephone 210C (e.g., a cellular phone, a smart phone, etc.), and a laptop computer 210D with wireless communication capabilities. The AP 220 and devices 210A-210D are implemented in accordance with at least one wired and/or wireless communication standard. Further, at least one device 210 comprises a hook detection circuit as described herein.

In the example of FIG. 2, to enable the plurality of devices 210A-210D to communicate with devices and/or servers located outside network 200, AP 220 is communicatively coupled via any of a variety of communication paths 230 to, for example, any of a variety of servers 240 associated with public and/or private network(s) such as the Internet 250. Server 240 may be used to provide, receive and/or deliver services such as data, video, audio, telephone, gaming, Internet, messaging, electronic mail, or other services. Additionally or alternatively, network 200 may be communicatively coupled to any of a variety of public, private and/or enterprise communication network(s), computer(s), workstation(s) and/or server(s) to provide any of a variety of voice service(s), data service(s) and/or communication service(s).

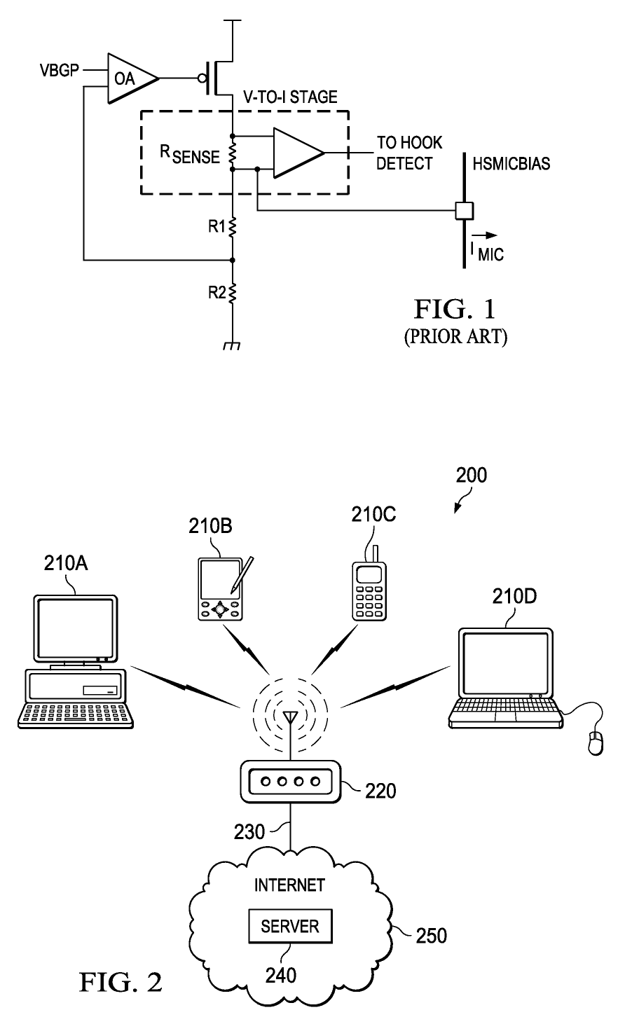

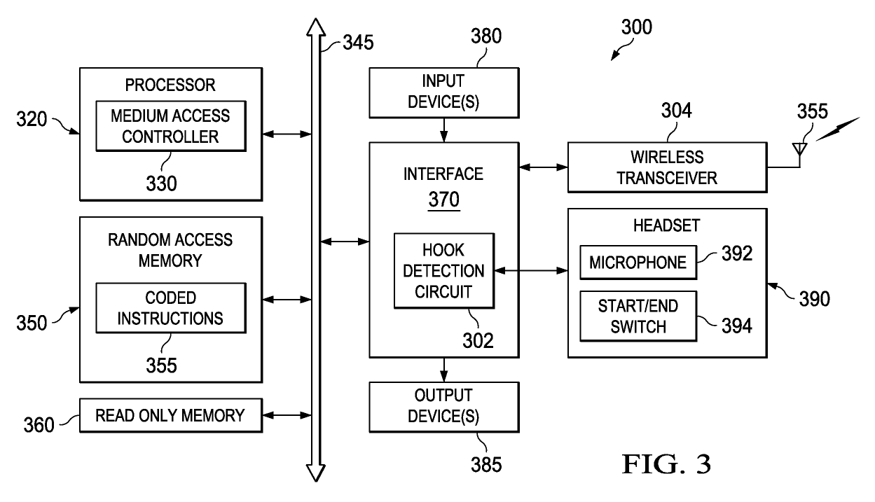

FIG. 3 illustrates a computer system 300 in accordance with embodiments. In at least some embodiments, the computer system 300 is suitable for implementing wireless device 100 of FIG. 1 or the devices 210A-210D of FIG. 2. As shown, the exemplary computer system 300 comprises processor(s) 320. It should be appreciated that processor 320 may be at least one of a variety of processors such as, for example, a microprocessor, a microcontroller, a central processor unit (CPU), a main processing unit (MPU), a digital signal processor (DSP), an advanced reduced instruction set computing (RISC) machine, an (ARM) processor, etc. Processor 320 executes coded instructions 355 which may be present in a main memory of the processor 320 (e.g., within a random-access memory (RAM) 350) and/or within an on-board memory of the processor 320. Processor 320 communicates with memory (including RAM 350 and read-only memory (ROM) 360) via bus 345. RAM 350 may be implemented by dynamic RAM (DRAM), synchronous dynamic RAM (SDRAM), and/or any other type of RAM device. ROM 360 may be implemented by flash memory and/or any other type of memory device.

Processor 320 implements medium access controller (MAC) 330 using one or more of any of a variety of software, firmware, processing thread(s) and/or subroutine(s). In at least some embodiments, MAC 330 may be implemented by hardware, software, firmware or a combination thereof, including using an application specific integrated circuit (ASIC), a programmable logic device (PLD), a field programmable logic device (FPLD), discrete logic, or other components.

The computer system 300 also preferably comprises at least one input device 380 (e.g., keyboard, touchpad, buttons, keypad, switches, dials, mouse, track-ball, voice recognizer, card reader, etc.) and at least one output device 385 (e.g., liquid crystal display (LCD), printer, video monitor, touch screen display, a light-emitting diode (LED), etc.)—each of which are communicatively connected to interface 370.

In at least some embodiments, interface 370 comprises a hook detection circuit 302. The hook detection circuit 302 implements current sensing rather than voltage sensing to establish if a hook button (e.g., a start/end switch) is pushed or not. In accordance with embodiments, the hook detection circuit 302 is programmable for use with series start/end switching or parallel start/end switching as will later be described in greater detail.

As shown, the hook detection circuit 302 receives input from a headset 390 having a microphone 392 and a start/end switch 394. Electronically, the start/end switch 394 is either in series or in parallel with the microphone 392. By toggling (e.g., pushing) the start/end switch 394, a user is able to start and end a function (e.g., telecommunications or other functions) of the computer system 300.

In at least some embodiments, interface 370 also communicatively couples a wireless transceiver 304 and radio frequency (RF) antenna 355 to the processor 320 and/or MAC 330. The RF antenna 355 and wireless transceiver 304 support any of a variety of wireless signals, wireless protocols and/or wireless communications. RF antenna 355 and wireless transceiver 304 enable the computing system 300 to receive, demodulate and decode signals transmitted in a wireless network. Likewise, wireless transceiver 304 and RF antenna 355 enable the computing system 300 to encode, modulate and transmit wireless signals to other devices of a wireless network. In some embodiments, RF antenna 355 and transceiver 304 correspond to the “physical layer” (PHY) of the computer system 300. Although wireless communications are described for the computer system 300, it is of course possible to implement the function of the hook detection circuit 302 in embodiments with wired communications.

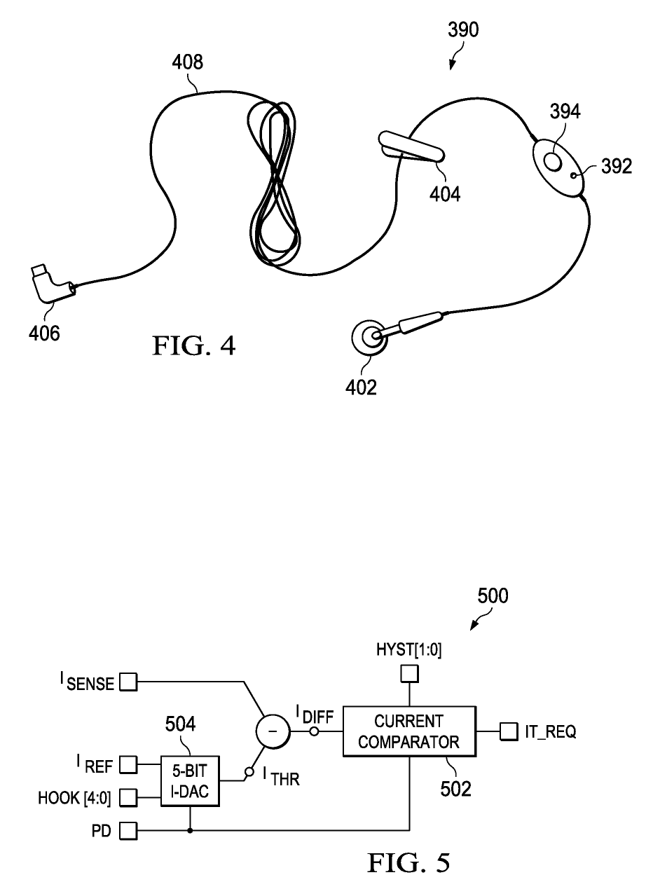

FIG. 4 illustrates the headset 390 of FIG. 3 in accordance with embodiments. As shown, the headset 390 includes the microphone 392 and the start/end switch 394 as described previously. The headset 390 also may include an earpiece speaker 402, a clip 404 and/or a plug 406. Various components of the headset 390 (e.g., the microphone 392, the start/end switch 394, and the earpiece speaker 402) receive power and/or signals via an insulated conductor 408 that extends between these components and the plug 406. The plug 406 couples the headset 390 to the computer system 300, for example, by mating with a corresponding connector of the interface 370 such that power and/or signals are transmitted between the headset 390 and the interface 370. In accordance with embodiments, the hook detection circuit 302 receives signals from the headset 390 and detects when the start/end switch 394 is toggled. Upon detecting such toggling, the hook detection circuit 302 reports to the processor 320 and/or the wireless transceiver 304 in order to start or to end a function (e.g., telecommunications).

FIG. 5 illustrates a hook detection circuit 500 in accordance with embodiments. In at least some embodiments, the hook detection circuit 500 corresponds to the hook detection circuit 302 of FIG. 3. As shown, the hook detection circuit 500 comprises a current comparator 502 that receives a current difference (I_{DIFF}) between an input current (I_{SENSE}) and a selected current threshold (I_{THR}). I_{SENSE}, for example, may be received from the headset 390. Meanwhile, I_{THR} may be received from a current digital-to-analog converter (I-DAC) 504. The current comparator 502 and the I-DAC 504 selectively receive a Power Down (PD) signal.

Although other embodiments are possible, the I-DAC 504 is shown as a programmable 5-bit I-DAC in FIG. 5. Accordingly, the I-DAC 504 may be programmed using a multi-bit control signal (“Hook [4:0]”). In response to the multi-bit control signal and a current reference (I_{REF}), the I-DAC 505 outputs I_{THR}. As an example, I_{THR} may range from 25 μA/M to 800 μA/M, where M is the mirroring factor. The mirroring factor is the ratio between Iₜₒ_{_{—}}ₛₑₙₛₑ (the current to sense in the current comparator 502) and I_{SENSE} (the current in the MICBIAS stage). Table 1 illustrates I_{THR} values output by the I-DAC 504 in response to a 5-bit control signal.

TABLE 1

| | Current |
|---|---|
| Control code | threshold (I_{THR}) |
| 00000 | 25 μA/M |
| 00001 | 50 μA/M |
| 00010 | 75 μA/M |
| 00011 | 100 μA/M |
| 00100 | 125 μA/M |
| 00101 | 150 μA/M |
| 00110 | 175 μA/M |
| 00111 | 200 μA/M |
| 01000 | 225 μA/M |
| 01001 | 250 μA/M |
| 01010 | 275 μA/M |
| 01011 | 300 μA/M |
| 01100 | 325 μA/M |
| 01101 | 350 μA/M |
| 01110 | 375 μA/M |
| 01111 | 400 μA/M |
| 10000 | 425 μA/M |
| 10001 | 450 μA/M |
| 10010 | 475 μA/M |
| 10011 | 500 μA/M |
| 10100 | 525 μA/M |
| 10101 | 550 μA/M |
| 10110 | 575 μA/M |
| 10111 | 600 μA/M |
| 11000 | 625 μA/M |
| 11001 | 650 μA/M |
| 11010 | 675 μA/M |
| 11011 | 700 μA/M |
| 11100 | 725 μA/M |
| 11101 | 750 μA/M |
| 11110 | 775 μA/M |
| 11111 | 800 μA/M |

In accordance with some embodiments, default values for I_{THR} may be designated for series start/end switching, parallel start/end switching, or both. As an example, 125 μA/M (control code 00100) may be used as a default I_{THR} value for series start/end switching and 600 μA/M (control code 10111) may be used as a default I_{THR} value for parallel start/end switching.

As shown, the current comparator 502 selectively employs at least one hysteresis level to debounce an input signal. In FIG. 5, the current comparator's hysteresis level is based on a control signal (Hyst [1:0]). As an example, the current comparator 502 performs the current comparison using as thresholds I_{THR}+Δ (for rising edges) and I_{THR}−Δ (for falling edges), where Δ is selectively I_{THR}/20 (±5% hysteresis), I_{THR}/10 (±10% hysteresis), or 0 if hysteresis is disabled. Upon detecting a hook event (the start/end switch 394 being toggled), the current comparator 502 asserts an interrupt request (IT_REQ) to the host system in order to start or to end a function (e.g., telecommunications).

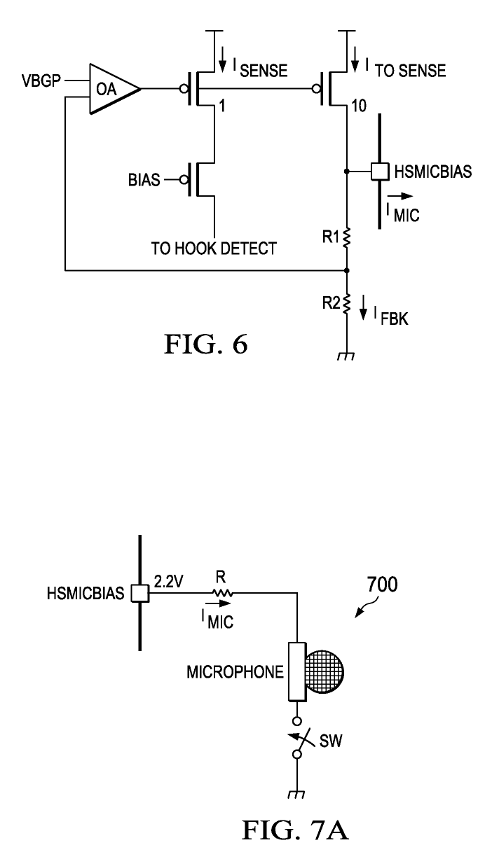

FIG. 6 illustrates a current sense arrangement 600 in accordance with embodiments. In the arrangement 600, I_{SENSE} is proportional (e.g., scaled down by a factor of 10) to Iₜₒ_{_{—}}ₛₑₙₛₑ, which is the current flowing in the microphone (I_{MIC}) plus the feedback current (I_{FBK}) which is determined from the components used in the arrangement 600. Thus, from I_{SENSE} the current going in the microphone (I_{MIC}) can be evaluated.

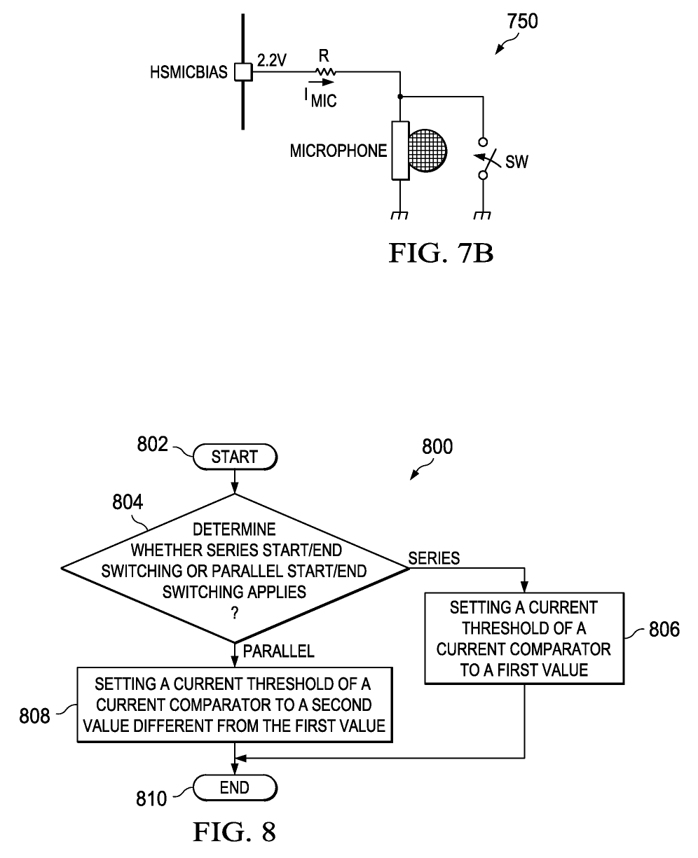

FIG. 7A illustrates a series start/end switch arrangement 700 in accordance with embodiments. In the arrangement 700, when start/end switch (SW) is closed,

$${I}_{to\_sense} = {I}_{MIC} + {I}_{FBK} = \frac{2.2 V}{R + {R}_{MIC}} + 57 µ A ,$$

where R_{MIC} is the output impedance of the microphone, 57 μA is the current through resistors R₁ and R₂, and I_{FBK} is the current needed to generate the feedback voltage level. As an example, if R=3 kΩ and R_{MIC}=13.7 kΩ, then Iₜₒ_{_{—}}ₛₑₙₛₑ is about 189 μA when SW is closed. On the other hand, Iₜₒ_{_{—}}ₛₑₙₛₑ is 57 μA when SW is opened. For this example, the choice of I_{THR} must be between 57 μA and 189 μA and thus a default I_{THR} value of 125 μA would be acceptable. To reduce power consumption, a mirroring value as described previously may be used. For example, if the mirroring value is 10 (i.e., I_{SENSE}/Iₜₒ_{_{—}}ₛₑₙₛₑ=10) and I_{THR}=125 μA, the actual threshold used inside the current comparator 502 would be 12.5 μA.

FIG. 7B illustrates a parallel start/end switch arrangement 750 in accordance with embodiments. In the arrangement 750, when the start/end switch (SW) is closed,

$${I}_{to\_sense} = \frac{2.2 V}{R} + 57 µ A .$$

Using the previously assumed value for R (R=3 kΩ), Iₜₒ_{_{—}}ₛₑₙₛₑ is about 790 μA when SW is closed. In contrast, when SW is opened,

$${I}_{to\_sense} = {I}_{MIC} + {I}_{FBK} = \frac{2.2 V}{R + {R}_{MIC}} + 57 µ A = 57 µ A .$$

For this example, the choice of I_{THR} must be between 57 μA and 790 μA and thus a default I_{THR} value of 600 μA would be acceptable. If a mirroring value of 10 is used as previously described, the actual threshold used inside the current comparator 502 would be 60 μA. Being able to program I_{THR} advantageously provides flexibility to the hook detection circuit 500. For example, I_{THR} can be adapted for use with any microphone (and the microphone's related output impedance R_{MIC}). Further, by ensuring that the spread for current detection by the current comparator 502 is less than predetermined threshold, the hook detection circuit 500 can be programmed for either series start/end switching or parallel start/end switching while maintaining sufficient accuracy.

FIG. 8 illustrates a hook detection method 800 in accordance with embodiments. As shown, the method 800 starts (block 802) by determining whether series start/end switching or parallel start/end switching applies (decision block 804). If series start/end switching applies (decision block 804), a current threshold of a current comparator is set to a first value (block 806). If parallel start/end switching applies (decision block 804), the current threshold of the current comparator is set to a second value different from the first value (block 808). The method 800 ends at block 810 and can be repeated as needed.

In at least some embodiments, the first and second values correspond to default values, which have been determined based on a series start/end switch arrangement (e.g., arrangement 700) or a parallel start/end switch arrangement (e.g., arrangement 750). The method 800 may also include determining microphone parameters (e.g., a microphone's output impedance) and selectively adjusting the current threshold from a default value based on the microphone parameters. In accordance with at least some embodiments, the method 800 also may include setting the current threshold by providing a multi-bit control signal to the current comparator and/or selectively setting a hysteresis function of the current comparator.

The above discussion is meant to be illustrative of the principles and various embodiments of the present invention. Numerous other variations and modifications will become apparent to those skilled in the art once the above disclosure is fully appreciated. It is intended that the following claims be interpreted to embrace all such variations and modifications.

What is claimed is:

1. A communication device, comprising:
a processor;
a communication interface coupled to the processor, the communication interface having a programmable current-based hook detection circuit for detecting when a telephonic communication starts and ends.

2. The communication device of claim 1 further comprising a microphone coupled to the communication interface, wherein the programmable current-based hook detection circuit is selectively programmed to detect signals from a start/end switch in series with the microphone.

3. The communication device of claim 1 further comprising a microphone coupled to the communication interface, wherein the programmable current-based hook detection circuit is selectively programmed to detect signals from a start/end switch in parallel with the microphone.

4. The communication device of claim 1 further comprising a headset having a microphone and a start/end switch coupled to the communication interface, wherein the programmable current-based hook detection circuit comprises a current comparator set to a default series configuration threshold when the microphone and the start/end switch are in series.

5. The communication device of claim 1 further comprising a headset having a microphone and a start/end switch coupled to the communication interface, wherein the programmable current-based hook detection circuit comprises a current comparator set to a default parallel configuration threshold when the microphone and the start/end switch are in parallel.

6. The communication device of claim 1 wherein the programmable current-based hook detection circuit comprises a current comparator having a current threshold based on a multi-bit control signal, wherein the current threshold is set lower for series start/end switching than for parallel start/end switching.

7. The communication device of claim 1 wherein the programmable current-based hook detection circuit comprises a current comparator having a programmable current threshold based on one of a default series threshold value and a default parallel threshold value and based on a microphone parameter.

8. The communication device of claim 1 wherein the programmable current-based hook detection circuit comprises a current comparator having a programmable hysteresis to debounce an input signal.

9. A hook detection circuit for detecting when a telephonic communication starts and ends, comprising:
a current comparator programmable for both series start/end switching and parallel start/end switching.

10. The hook detection circuit of claim 9 wherein a current threshold of the current comparator is programmed based on at least one of a default series current threshold and a default parallel current threshold.

11. The hook detection circuit of claim 10 wherein the current threshold of the current comparator is selectively adjusted from one of the default thresholds based on a microphone parameter.

12. The hook detection circuit of claim 10 wherein the current threshold of the current comparator is programmed using a multi-bit control signal.

13. The hook detection circuit of claim 9 wherein the current comparator has a programmable hysteresis to debounce an input signal.

14. The hook detection circuit of claim 9 wherein the current comparator is selectively set to one of a plurality of current thresholds approximately between 25 μA/M to 800 μA/M, where M is a mirroring factor.

15. The hook detection circuit of claim 9 wherein a spread threshold maintained by the current comparator is less than a predetermined value to enable support for series start/end switching and parallel start/end switching.

16. A hook detection method, comprising:
determining whether series start/end switching or parallel start/end switching applies;
if series start/end switching applies, setting a current threshold of a current comparator to a first value; and
if parallel start/end switching applies, setting the current threshold of the current comparator to a second value different from the first value.

17. The hook detection method of claim 16 wherein setting the current threshold comprises providing a multi-bit control signal to the current comparator.

18. The hook detection method of claim 16 further comprising selectively setting a hysteresis function of the current comparator.

19. The hook detection method of claim 16 further comprising determining default values for the first and second values.

20. The hook detection method of claim 16 further comprising determining microphone parameters and selectively adjusting the current threshold from a default value based on said microphone parameters.
